(19) United States
(12) Patent Application Publication
(10) Pub. No.: US 2002/0087990 A1
(43) Pub. Date: Jul. 4, 2002

(54) System for transmitting data via satellite

(76) Inventor: Jim Bruton, West Haven, CT (US)

Correspondence Address: NILLES & NILLES, S.C., INTELLECTUAL PROPERTY ATTORNEYS, FIRSTAR CENTER, SUITE 2000, 777 EAST WISCONSIN AVENUE, MILWAUKEE, WI, 53202-5345, US

(21) Appl. No.: 10/005,901

(22) Filed: Dec. 5, 2001

Related U.S. Application Data
(60) Provisional application No. 60/251,418, filed on Dec. 5, 2000.

(51) Int. Cl. H04N 7/20; H04N 7/173

(52) U.S. Cl. 725/63; 725/106

(57) ABSTRACT

Wireless, telephone-based satellite-linked communication system for transmitting a present-time signal to any point on the earth. The telephone-based satellite-linked communication system comprises a digital-based wireless telecommunication system and a digital-based satellite-linked telecommunication system. The digital-based wireless telecommunication system obtains visual and auditory information of a present-time event at one point on the earth and produces a digital-based signal corresponding to the present-time event. The digital-based satellite-linked telecommunication system is receives the digital-based signal corresponding to the present-time event and transmits to substantially any other point on the earth the digital-based signal corresponding to the present-time event. The transmitted digital-based signal has an error-to-signal ratio sufficiently low as to be deemed substantially satisfactory to a select number of viewers.

### BACKGROUND OF THE INVENTION

1. Field of the Invention

The present invention is directed to a system for transmitting live and archived data, including video and audio data, from the field via portable satellite-linked systems.

2. Background of the Invention

Generally unappreciated is the fact that in-the-field, live-television documentaries and news programs involving, e.g., the Middle East, Europe, Africa, and South and Central America as well as expeditions to Mount Everest, the North Pole, Antarctica, Greenland and Siberia are the result of individuals who are able to take technological principles and apply such principles to solve current technological problems. The remote locations and extreme environments of many in-the-field, live-television documentaries and news programs pose a variety of problems to current wireless video and satellite-based telecommunications technologies. One particular case in point involves the innovative integration of cutting-edge, field-located and satellite-based telecommunications systems technologies.

For example, operatively connecting a video/audio telephone system located in the field to a telephone system linked to a satellite has provided marginal success for purposes of transmitting full-duplex live video/audio signals between global endpoints via the resultant satellite-linked dual telephone-system communications pathway. In other words, transmitting full-duplex live video between two endpoints via commercial satellite communications pathways has generally existed since approximately late 1993 to early 1994, but this type of transmission has not been commercially reliable because the telephone systems produce an error-to-signal ratio that is undesirably high. Therefore, the resultant field-located, satellite-based communication system is not commercially successful, principally for the reason that its transmission signal is viewed as unpredictable and thus unreliable.

Further compounding the problem is the fact that transmitted full-duplex live video/audio signals, if they are to have any measurable commercial value, must have an error-to-signal ratio that is sufficiently low as to be deemed satisfactory to global television and computer monitor viewers around the world via the internet.

What is needed, therefore, is an apparatus and method for transmitting full-duplex live video/audio signals to all global television and computer monitor viewers around the world. It is also desirable to transmit these signals to a select number of subscribers for a fee.

### SUMMARY OF THE INVENTION

According to a first aspect of the preferred embodiment of the present invention, an improved wireless, telephone-based satellite-linked communication system for transmitting a present-time signal to any point on the earth includes a digital-based wireless telecommunication system adapted to obtain visual and auditory information of a present-time event at one point on the earth and to produce a digital-based signal corresponding to the present-time event. The system further includes a digital-based satellite-linked telecommunication system operatively connected to the wireless telecommunication system and adapted to receive the digital-based signal corresponding to the present-time event and to transmit to substantially any other point on the earth the digital-based signal corresponding to the present-time event, wherein the transmitted digital-based signal has an error-to-signal ratio sufficiently low as to be deemed substantially satisfactory to a select number of viewers.

According to another aspect of the invention, an improved wireless, telephone-based satellite-linked communication system for transmitting a present-time signal to any point on the earth includes a digital-based wireless telecommunication system adapted to obtain visual and auditory information of a present-time event at one point on the earth and to produce a digital-based signal corresponding to the present-time event. The system further includes a digital-based satellite-linked telecommunication system operatively connected to the wireless telecommunication system and adapted to receive the digital-based signal corresponding to the present-time event and to transmit to substantially any other point on the earth the digital-based signal corresponding to the present-time event, wherein the transmitted digital-based signal has an error-to-signal ratio sufficiently low as to be deemed substantially satisfactory to a select number of viewers. The select number of viewers is a select number of global television and computer monitor viewers around the world via the internet.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is a block diagram of a system for transmitting present-time video and audio data over a commercial satellite system according to the present invention.

### DETAILED DESCRIPTION OF THE PREFERRED EMBODIMENTS

An improved wireless, telephone-based satellite-linked communication system for transmitting a present-time signal to any point on the earth includes a digital-based wireless telecommunication system and a digital-based satellite-linked telecommunication system operably connected to the wireless system. The digital-based wireless telecommunication system is adapted to obtain visual and auditory information of a present-time event at one point on the earth and to produce a digital-based signal corresponding to the present-time event. The satellite-linked telecommunication system is also adapted to receive the digital-based signal corresponding to the present-time event and to transmit to substantially any other point on the earth the digital-based signal. The transmitted digital-based signal has an error-to-signal ratio sufficiently low as to be deemed substantially satisfactory to a select number of viewers.

Preferably, the select number of viewers is a select number (e.g., paid subscribers) of global television and computer monitor viewers around the world via the Internet.

Further in that regard, the transmitted digital-based signal is preferably viewed live by the select number of global television and computer monitor viewers.

The digital-based wireless telecommunication system includes a commercially-available video compression device for producing digital-based compressed video signals corresponding to compressed visual information of the above-noted present-time event. In that regard, the satellite-linked telecommunication system is preferably further adapted to receive the digital-based compressed video signals and to transmit to substantially any other point on the earth the digital-based compressed video signals. The transmitted digital-based compressed (e.g., video) signals have an error-to-signal ratio that is sufficiently low as to be deemed substantially satisfactory to the above-noted select number of global television and computer monitor viewers.

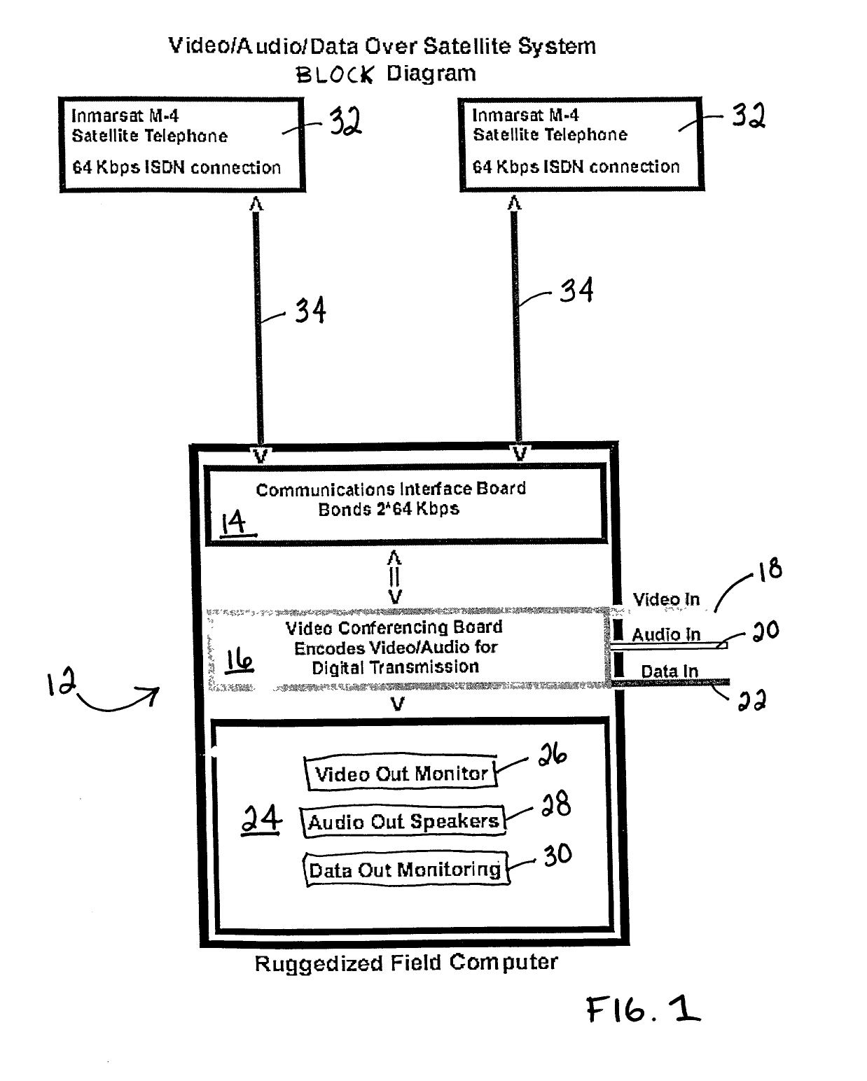

Referring now to the accompanying FIG. 1, a data-transmission system 10 includes a commercially-available field computer 12. Illustrative examples are commercially-available personal computers (PCs), notebooks, laptops, and smaller computers adapted for data input and output as described herein. The field computer 12 is preferably “ruggedized” meaning that the illustrated field computer 12 is adapted (or adaptable) to be fully functional in rugged conditions, i.e., remote locations and extreme environments.

Field computer 12 includes a communications interface board 14 and a video conferencing board 16. Interface board 14 is commercially available and is able to bond two separate 64 thousand bytes per second (64 Kbps) signal bundles. Video conferencing board 16 is commercially available and is able to encode video/audio signals for digital transmission. Preferably, video conferencing board 16 is able to bundle and encrypt such signals for security purposes. Video conferencing board 16 receives a video input signal via a video in connection 18, an audio input signal via a connection 20, and other data via a connection 22. Such video, audio and other data is preferably live.

Field computer 12 further includes an output section 24 that includes a video output monitor 26, audio output speakers 28, and a monitor 30 for other output data, as is available and able to be transmitted in accordance with this invention.

Wireless, telephone-based satellite-linked communication system 10 of the present invention further includes at least one and preferably two satellite-telephone connecting systems 32, operably connected to digital-based field computer 12 via wireless transmission signals 34. In the preferred embodiment of the present invention, a single Inmarasat-B digital satellite telephone is able to boost the bandwidth to 64 Kbps.

Each satellite-telephone system 32 preferably includes a commercially-available satellite telephone connection. Commercially-available SO (RJ-45 , Eurostand) communications interfaces are preferably employed. Also preferably employed are commercially-available video conference standards: H.320 with H.263 MPEG-1 and MPEG-2 store and forward capability. Commercially available communications software is capable of code modification as may be required for enabling satcomm connectivity, i.e. wireless connection to commercial satellite systems. The Inmarsat M-4 satellite telephone connection providing 64 Kbps ISDN is preferred.

What has been illustrated and described herein is a wireless, telephone-based satellite-linked communication system for transmitting a present-time signal to any point on the earth, for live and/or archived purposes. Further in that regard, as the wireless, telephone-based satellite-linked communication system has been illustrated and described with reference to a preferred embodiment, it is to be understood that the invention is not to be limited to such an embodiment. In particular, and as those skilled in the relevant art can appreciate, functional alternatives will become apparent after reviewing this patent specification. Accordingly, all such functional equivalents, alternatives, and/or modifications are to be considered as forming a part of the invention insofar as they fall within the spirit and scope of the appended claims.

The scope of the application is not to be limited by the description of the preferred embodiments described above, but is to be limited solely by the scope of the claims that follow.

What is claimed is:

1. An improved wireless, telephone-based satellite-linked communication system for transmitting a present-time signal to any point on the earth, comprising:
a digital-based wireless telecommunication system adapted to obtain visual and auditory information of a present-time event at one point on the earth and to produce a digital-based signal corresponding to the present-time event; and
a digital-based satellite-linked telecommunication system operatively connected to the wireless telecommunication system and adapted to receive the digital-based signal corresponding to the present-time event and to transmit to substantially any other point on the earth the digital-based signal corresponding to the present-time event, wherein the transmitted digital-based signal has an error-to-signal ratio sufficiently low as to be deemed substantially satisfactory to a select number of viewers.

2. The improved satellite-linked communication system of claim 1, wherein the select number of viewers is a select number of global television and computer monitor viewers around the world via the internet.

3. The improved satellite-linked communication system of claim 2, wherein the transmitted digital-based signal is viewed live by the select number of global television and computer monitor viewers around the world via the internet.

4. The improved satellite-linked communication system of claim 2, wherein the digital-based wireless telecommunication system includes a video compression device for producing digital-based compressed video signals corresponding to compressed visual information of the present-time event, and wherein the satellite-linked telecommunication system is further adapted to receive the digital-based compressed video signals and to transmit to substantially any other point on the earth the digital-based compressed video signals, wherein said transmitted digital-based compressed video signals have an error-to-signal ratio sufficiently low as to be deemed substantially satisfactory to the select number of global television and computer monitor viewers around the world via the internet.

5. An improved wireless, telephone-based satellite-linked communication system for transmitting a present-time signal to any point on the earth, comprising:
a digital-based wireless telecommunication system adapted to obtain visual and auditory information of a present-time event at one point on the earth and to produce a digital-based signal corresponding to the present-time event;
a digital-based satellite-linked telecommunication system operatively connected to the wireless telecommunication system and adapted to receive the digital-based signal corresponding to the present-time event and to transmit to substantially any other point on the earth the digital-based signal corresponding to the present-time event, wherein the transmitted digital-based signal has an error-to-signal ratio sufficiently low as to be deemed substantially satisfactory to a select number of viewers; and
wherein the select number of viewers is a select number of global television and computer monitor viewers around the world via the internet.

6. The improved satellite-linked communication system of claim 5, wherein the transmitted digital-based signal is viewed live by the select number of global television and computer monitor viewers around the world via the internet.

7. The improved satellite-linked communication system of claim 5, wherein the digital-based wireless telecommunication system includes a video compression device for producing digital-based compressed video signals corresponding to compressed visual information of the present-time event, and wherein the satellite-linked telecommunication system is further adapted to receive the digital-based compressed video signals and to transmit to substantially any other point on the earth the digital-based compressed video signals, wherein said transmitted digital-based compressed video signals have an error-to-signal ratio sufficiently low as to be deemed substantially satisfactory to the select number of global television and computer monitor viewers around the world via the internet.
